(19) United States
(12) Patent Application Publication
(10) Pub. No.: US 2024/0147342 A1
(43) Pub. Date: May 2, 2024

(54) SYSTEMS AND METHODS FOR INTELLIGENT MULTIPLEXING IN A WIRELESS ACCESS ROUTER

(71) Applicant: Verizon Patent and Licensing Inc., Basking Ridge, NJ (US)

(72) Inventors: Lily Zhu, Parsippany, NJ (US); Balaji L. Raghavachari, Bridgewater, NJ (US); Wenyuan Lu, Raritan, NJ (US); Le Su, Edison, NJ (US)

(21) Appl. No.: 18/051,152

(22) Filed: Oct. 31, 2022

(51) Int. Cl. H04W 40/12; H04W 24/08; H04W 28/02

(52) U.S. Cl. CPC H04W 40/12; H04W 24/08; H04W 28/0284

(57) ABSTRACT

Systems and methods described herein intelligently multiplex different types of traffic in a fixed wireless access (FWA) environment by communicating with the user/application directly so that the network capacity can be maximized for different types of traffic. A routing device in a customer premises network receives a routing policy and receives an indication of network congestion conditions. The routing device identifies one or more sources of delay-tolerant traffic in the customer premises network, such as a local area network (LAN), and applies the routing policy to delay data transmissions from the source based on identifying the indication of network congestion conditions.

### BACKGROUND

Residential, business, and public spaces may implement a Layer 2 and/or Layer 3 local area network (LAN) that enables connectivity for user devices to broadband Internet or other large-scale public networks over a radio access network (RAN). For example, a customer location may be served by customer premises equipment (CPE) that includes a fixed wireless access (FWA) device from a network service provider. The FWA device may connect to, or function as, a WiFi access point (AP) that provides short-range wireless access for the CPE and/or user devices. Each user device may have its own service profile and may connect to broadband Internet via an air interface (e.g., the RAN) using the CPE, e.g., the FWA device.

### BRIEF DESCRIPTION OF THE DRAWINGS

FIGS. 1A and 1B are diagrams illustrating a network environment, according to an implementation described herein;

FIG. 2 is a diagram illustrating an example configuration to implement artificial intelligence (AI)-based multiplexing;

FIG. 3 is a diagram illustrating example components of a device that may correspond to one or more of the devices illustrated and described herein;

FIG. 4 is a diagram illustrating logical components of an AI-machine learning (AIML) engine, according to an implementation;

FIG. 5 is a diagram illustrating exemplary communications for providing static category-based multiplexing;

FIG. 6 is a diagram illustrating exemplary communications for providing dynamic application-specific multiplexing; and

FIG. 7 is a flow diagram illustrating an example process for providing intelligent multiplexing in a CPE network, according to an implementation.

### DETAILED DESCRIPTION OF EXAMPLE EMBODIMENTS

The following detailed description refers to the accompanying drawings. The same reference numbers in different drawings may identify the same or similar elements.

Fixed wireless access (FWA) is applicable, for example, in individual households and multiple dwelling units (MDUs). For individual households, a FWA device may provide broadband cellular communications for a single local area network (LAN) or wireless LAN (WLAN). For MDUs, a FWA device may support multiple LANs or WLANs. FWA devices are typically provided as customer premises equipment (CPE) that includes a modem and a router. The router may be designed to perform a number of functions that includes processing routing protocols, using routing protocols to determine best routes, and routing Internet Protocol (IP) packets.

An FWA service shares the same mobile network that also serves other mobile devices (e.g., smartphones, tablets, wearables, etc.). In any given service area (e.g., a cell site), the wireless spectrum for the mobile network has a limited bandwidth and/or capacity. Given the “always connected” nature of fixed wireless traffic and the use case of MDUs, the network demand from FWA devices poses a significant challenge. Today, typically, the CPE has no intelligence to help the mobile network optimize traffic and manage congestion on the LAN side. In other words, in the FWA use-case scenario, a wide area network (WAN), the LAN, and all the nodes in between are logically disjointed. Solutions are needed for FWA devices to intelligently manage and multiplex the LAN/WLAN traffic to optimize cellular WAN connectivity and capacity. As CPE, the FWA device may sit between the LAN and WAN and is well-suited to interact with and/or manage the LAN to help address WAN congestion.

Systems and methods described herein intelligently multiplex different types of traffic in an FWA environment, by having the FWA devices communicate with the user/application directly so that the network capacity can be maximized for different types of traffic. The systems and methods may intelligently identify a traffic type that needs immediate attention (e.g., in contrast with delay-tolerant traffic). In one aspect, the systems and methods may use artificial intelligence to learn user traffic patterns, predict and/or detect network loading/congestion, learn neighboring cell traffic patterns, etc., and derive traffic management policies for FWA devices.

According to an implementation, a routing device (e.g., an FWA device) in a customer premises network receives, from a core network, a traffic management policy and, at some later time, identifies an indication of network congestion conditions. The routing device identifies a source of delay-tolerant traffic in the customer premises network and applies the traffic management policy to delay data transmissions from the source based on identifying the indication of network congestion conditions.

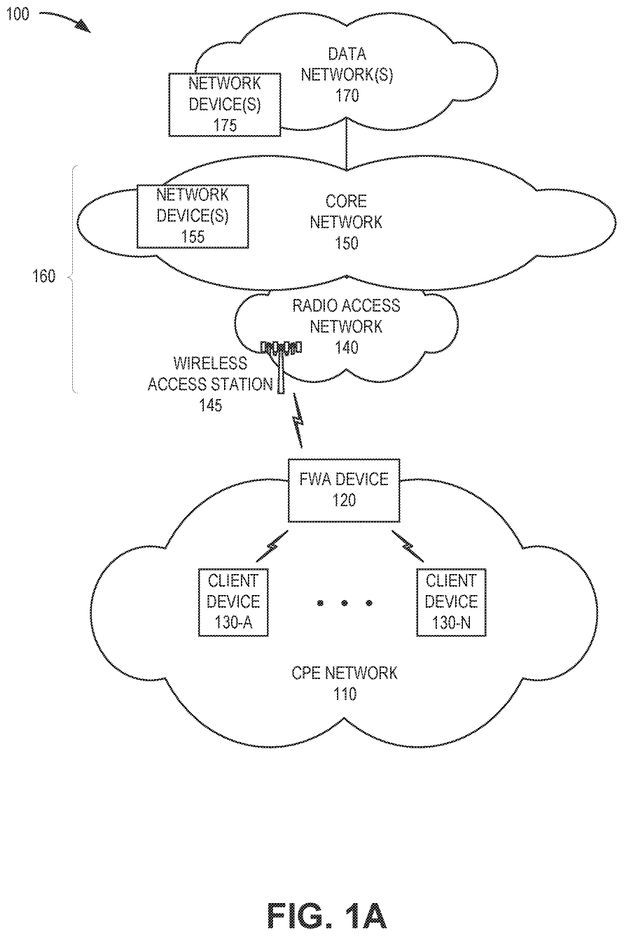

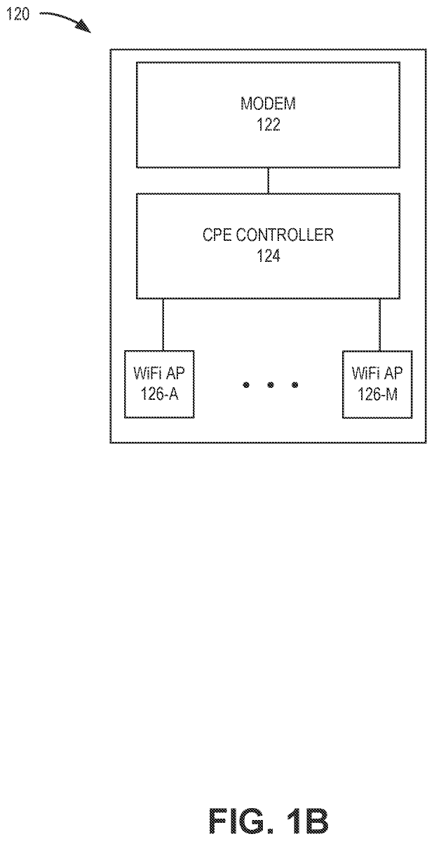

FIGS. 1A and 1B are diagrams of an exemplary environment 100 in which the systems and/or methods, described herein, may be implemented. As shown in FIG. 1A, environment 100 may include a customer premises equipment (CPE) network 110, a radio access network (RAN) 140, a core network 150, and one or more data networks 170. CPE network 110 may include an FWA device 120 and client devices 130-A to 130-N (referred to herein collectively as “client devices 130” and individually as “client device 130”). RAN 140 and core network 150 may be collectively referred to herein as “provider network 160.” According to other embodiments, environment 100 may include additional networks, fewer networks, and/or different types of networks than those illustrated and described herein.

CPE network 110 may include a local area network (LAN) associated with a customer's premises. For example, CPE network 110 may be located at or in a residence, an apartment complex, a school campus, an office building, a shopping center, a connected mass transit vehicle (e.g., bus, train, plane, boat, etc.), and/or in another type of location associated with a customer of a network service provider. CPE network 110 may request/receive one or more data services via a wireless connection between FWA device 120 and a data network 170, such as, for example, a video streaming service, an Internet service, and/or a voice communication (e.g., phone) service. CPE network 110 may be implemented, for example, as a gigabit network that enables gigabit speed connections.

FWA device 120 may connect client devices 130 to RAN 140 through one or more wireless access stations 145 via over the air (OTA) signals. FWA device 120 may function as a user equipment (UE) device with respect to wireless access stations 145. According to implementation described herein, FWA device 120 may implement artificial intelligence (AI)-based multiplexing at the LAN side (e.g., CPE network 110) to help provider network 160 optimize traffic and manage congestion.

As shown in FIG. 1B, FWA device 120 may include a modem 122, a CPE controller 124, WiFi access points (APs) 126-A to 126-M (referred to herein collectively as “WiFi APs 126” and individually as “WiFi AP 126”). FWA device 120 may be installed as CPE in a designated service location at, or near, the customer premises, such as outside of a structure (e.g., on a roof, attached to an exterior wall, etc.) or inside a structure (e.g., next to a window or another structural feature with lower radio signal attenuation properties). In another implementation, FWA device 120 may include distributed components (e.g., with parts of FWA device 120 at different locations on or near the customer premises).

Modem 122 may be configured to connect to RAN 140 and communicate with elements of provider network 170. Modem 122 may be configured to communicate via a 4G Long-Term Evolution (LTE) air interface and/or a 5G New Radio (NR) air interface. Modem 122 may be configured to operate within or proximate to the customer address that is designated by the service provider.

CPE controller 124 may include a network device configured to function as a switch and/or router for client devices in CPE network 110. CPE controller 124 may connect devices in CPE network 110 to one another and/or to other FWA devices 120. CPE controller 124 may include a layer 2 and/or layer 3 network device, such as a switch, a router, an extender, a repeater, a firewall, and/or gateway and may support different types of interfaces, such as an Ethernet interface, a WiFi interface, a Multimedia over Coaxial Alliance (MoCa) interface, and/or other types of interfaces.

According to implementations described herein, CPE controller 124 may monitor for and detect congestion levels in provider network 160. For example, CPE controller 124 may inspect packets for congestion notices (e.g., an Explicit Congestion Notification (ECN)-specific field within the IP header (i.e., the ECN-capable Transport bit and the Congestion Experienced bit). As another example, CPE controller 124 may monitor uplink (UL) queues for excessive queue length and/or dropped packets. In still another example, CPE controller 124 may receive congestion indications from a host application (e.g., executing on network device 175). Additionally, or alternatively, CPE controller 124 may receive indications of network congestion from devices in provider network 160. CPE controller 124 may further manage WiFi APs 126 and/or client devices 130 connected to WiFi APs 126.

WiFi AP 126 may include a transceiver configured to communicate with client devices 130 using WiFi. WiFi AP 126 may enable client devices 130 to communicate with each other and/or with modem 122 via CPE controller 124. WiFi AP 126 may connect to CPE controller 124 via a wired connection (e.g., an Ethernet cable). Furthermore, WiFi APs 126 may include one or more Ethernet ports for connecting client devices 130 via a wired Ethernet connection. In some implementations, CPE controller 124 may include, and/or perform the functions of, WiFi AP 126. Other types of access points and/or short-range wireless devices may be implemented.

Client device 130 may include a device that connects to FWA device 120. Client device 130 may connect to FWA device 120 using wired (e.g., Ethernet) or wireless (e.g., WiFi) connections. For example, client device 130 may include a handheld wireless communication device (e.g., a mobile phone, a smartphone, a tablet device, etc.); a wearable computer device (e.g., a head-mounted display computer device, a head-mounted camera device, a wristwatch computer device, etc.); a global positioning system (GPS) device; a laptop computer or another type of portable computer; a desktop computer; a set-top box or a digital media player (e.g., Apple TV, Google Chromecast, Amazon Fire TV, etc.); a smart television; a portable gaming system; a home appliance device; a home monitoring device; and/or any other type of computer device with wireless communication capabilities. Client device 130 may be used for voice communication, mobile broadband services (e.g., video streaming, real-time gaming, premium Internet access etc.), best effort data traffic, and/or other types of services. As another example, client device 130 may correspond to an embedded wireless device (e.g., an Internet of Things (IOT) device) that communicates wirelessly with like devices over an M2M interface using MTC and/or another type of M2M communication. Client devices 130 may employ one or more applications to provide the services. According to implementations described herein, the applications may belong to assigned categories based on, for example, a level of delay tolerance for data transmissions.

RAN 140 may provide access to data network 170 for wireless cellular devices, such as FWA device 120. RAN 140 may enable FWA device 120 to connect to data network 170 for mobile telephone service, Short Message Service (SMS) message service, Multimedia Message Service (MMS) message service, Internet access, cloud computing, and/or other types of data services. RAN 140 may establish a connection between FWA device 120 and data network 170. For example, RAN 140 may establish an Internet Protocol (IP) connection between FWA device 120 and data network 170. Furthermore, RAN 140 may enable FWA device 120 to connect with an application server, and/or another type of device, located in data network 170 using a communication method that does not require the establishment of an IP connection between FWA device 120 and data network 170, such as, for example, Data over Non-Access Stratum (DoNAS). In some implementations, RAN 140 may include a 5G NR access network, an LTE Advanced (LTE-A) access network, an LTE access network, or a combination of access networks.

Wireless access station 145 may include a 5G base station (e.g., a gNB) that includes one or more radio frequency (RF) transceivers configured to send and receive wireless signals. According to an implementation, a wireless access station 145 may include a gNB or its equivalent with multiple distributed components, such as a central unit (CU), a distributed unit (DU), a remote unit (RU or a remote radio unit (RRU)), or another type of component to support distributed arrangements. In some implementations, wireless access station 145 may also include a 4G base station (e.g., an eNodeB). Furthermore, in some implementations, wireless access station 145 may include a Multi-Access Edge Computing (MEC) system that performs cloud computing and/or provides network processing services for client devices 130.

Core network 150 may include one or multiple networks of one or multiple network types and technologies. For example, core network 150 may be implemented to include an Evolved Packet Core (EPC) of an LTE network, an LTE-A network, an LTE-A Pro network, a Next Generation Core (NGC), a 5G Core Network (5GC) for a 5G network and/or a legacy core network. Core network 150 may be managed by a provider of data communication services and may manage data sessions of users connecting to core network 150 via RAN 140. According to one implementation, core network 150 may support a non-standalone (NSA) RAN network for dual coverage using 4G and 5G networks. According to another implementation, core network 150 may also support a standalone (SA) RAN for 5G services.

Depending on the implementation, core network 150 may include various network elements that may be implemented in network devices 155. Such network elements may include a user plane function (UPF), a session management function (SMF), a core access and mobility management function (AMF), a unified data management (UDM), a packet data network (PDN) gateway (PGW), a mobility and management entity (MME), a serving gateway (SGW), a policy charging rules function (PCRF), a policy function (PCF), a policy control, a home subscriber server (HSS), as well other network elements pertaining to various network-related functions, such as billing, security, authentication and authorization, network polices, subscriber profiles, network slicing, and/or other network elements that facilitate the operation of core network 150. In the context of a core network that is configured to support 5G UE devices (e.g., including FWA device 120), core network 150 may include one or more network devices 155 with combined 4G and 5G functionality, such as a session management function with PDN gateway-control plane (SMF+PGW-C) and a user plane function with PDN gateway-user plane (UPF+PGW-U).

Data network 170 may include one or multiple networks. For example, data network 170 may be implemented to include a service or an application-layer network, the Internet, an Internet Protocol Multimedia Subsystem (IMS) network, a Rich Communication Service (RCS) network, a cloud network, a packet-switched network, or other type of network that hosts a user device application or service. Depending on the implementation, data network 170 may include various network devices 175 that provide various applications, services, or other type of user device assets (e.g., servers (web servers, application servers, cloud servers, etc.), mass storage devices, data center devices), and/or other types of network services pertaining to various network-related functions.

Although FIGS. 1A and 1B show example components of environment 100, in other implementations, environment 100 may include fewer components, different components, differently arranged components, or additional components than depicted in FIGS. 1A and 1B. Additionally, or alternatively, one or more components of environment 100 may perform functions described as being performed by one or more other components of environment 100.

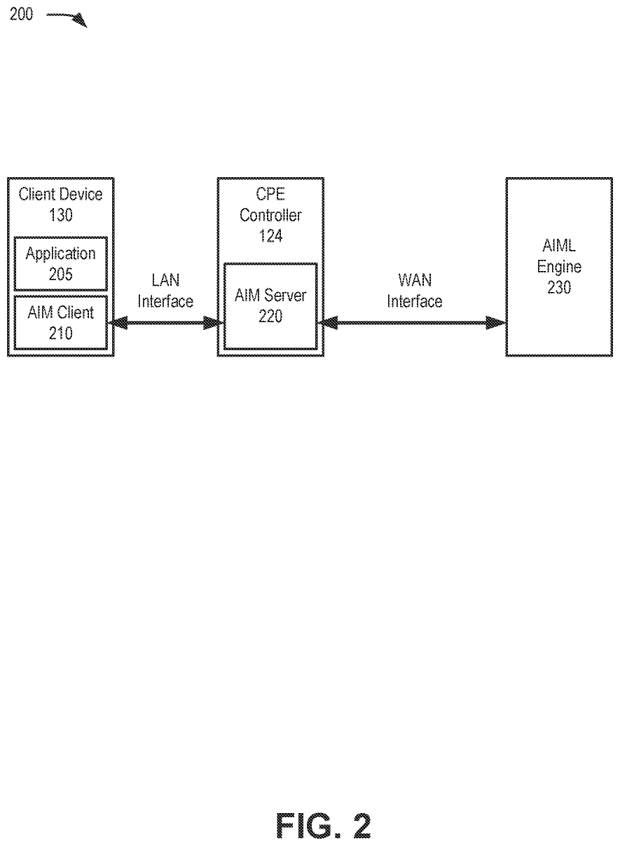

FIG. 2 is a diagram illustrating an example configuration to implement AI-based multiplexing in a portion 200 of network environment 100. More particularly, the AI-based multiplexing may enable CPE devices to help address WAN (e.g., provider network 160) capacity/connectivity congestion from the LAN side (e.g., CPE network 110). As shown in FIG. 2, network portion 200 to may include a client device 130 with an application 205 and an AI-based multiplexing (AIM) client 210, CPE controller 124 with an AIM server 220, and an AI-machine learning (AIML) engine 230.

Client device 130 may download, store, and/or register application 205. Application 205 may be an application that relies on data exchanges with a provider network 160 and/or data network 170. For example, application 205 may include a video streaming application, a web browser, a gaming application, etc. As another example, application 205 may provide device-specific functions, such as IOT device monitoring. Application 205 may transmit and receive network traffic via communications with other devices (e.g., network device 175, other client devices 130, etc.). Based on the use-case and/or purpose of application 205, communications for application 205 generate different categories of traffic, such as real-time data, low-latency data, best-effort data, etc. Thus, communications from some applications 205 may not be time sensitive (referred to herein as “delay-tolerant”).

AIM client 210 may be provided as a software development kit (SDK) for an application 205 or separate client software that interacts with AIM server 220 on behalf of an application 205. AIM client 210 may communicate with AIM server 220 to provide information (e.g., metadata) about traffic characteristics for the device 180/application 205, such as how often traffic is sent, traffic volume, transmit times, etc. According to one implementation, AIM client 210 may assist in a registration process whereby applications 205 may be categorized as delay-tolerant, time-sensitive, or another type. According to another implementation, AIM client 210 may generate traffic metadata, associated with application 205, to enable AIM server 220 and/or AIML engine 230 to dynamically detect the kind of traffic (e.g., delay-tolerant, time-sensitive, etc.) generated by application 205. In still another implementation, AIM client 210 may initiate a prompt to obtain user consent before implementing a pause for delay-tolerant traffic (e.g., during periods of network congestion).

AIM server 220 may store and execute traffic multiplexing rules from AIML engine 230, as well as local rules. AIM server 220 may collect metadata from different AIM clients 210 (e.g., from multiple client devices 130 and/or applications 205) in CPE network 110 and forward the collected data to AIML engine 230 for AI-based policy generation. AIM server 220 may receive a traffic management policy (e.g., a routing policy) from AIML engine 230 and, at some later time, identify an indication of network congestion conditions (e.g., congestion in the cell(s) supporting FWA 120 for CPE network 110). For example, as described above, CPE controller 124 may identify network congestion indications locally (e.g., via ECNs in packet headers, UL queue monitoring, etc.) or receive a congestion indication from a network device in provider network 160 or data network 175.

AIM server 220 may identify a source of delay-tolerant traffic (e.g., a client device 130 or application 205) in CPE network 110 based on either an application's registered category or a dynamic determination. AIM server 220 may apply the traffic management policy to delay (e.g., temporarily deactivate) data transmissions from the identified client device 130/application 205 in response to the indicated network congestion conditions. According to another implementation, AIM server 220 may also verify network slice selections (e.g., network slice selection assistance information (NSSAI) from application 205) is consistent with an application's registered category or the dynamic determination of traffic types.

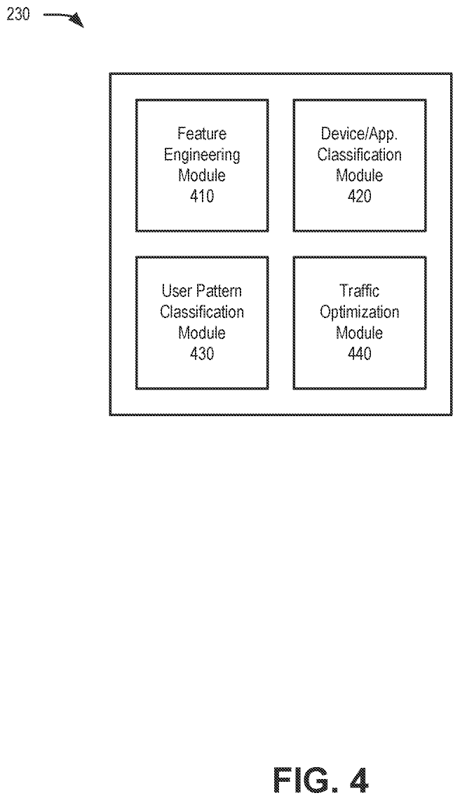

AIML engine 230 may correspond to a one or more of network devices 155 in core network 150. AIML engine 230 may be configured to learn user traffic patterns and push an optimized policy to AIM server 220. AIML engine is described further, for example, in connection with FIG. 4.

Although FIG. 2 illustrates certain components and communications for an AI-based multiplexing system, in other implementations, the AIM system may include fewer, different, or additional components than depicted in FIG. 2. Additionally, or alternatively, one or more components of the AIM service may perform functions described as being performed by one or more other components.

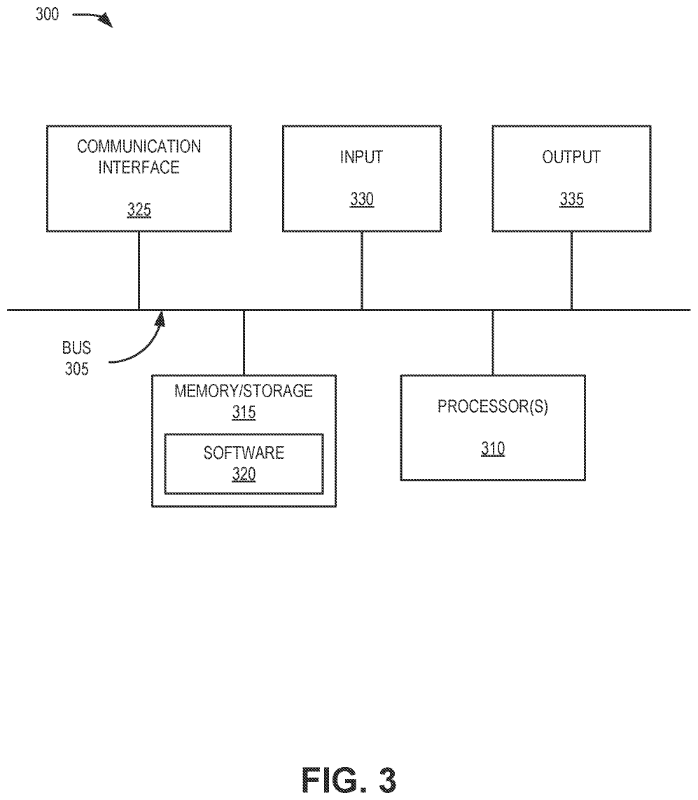

FIG. 3 is a diagram illustrating exemplary components of a device 300 that may correspond to one or more of the devices described herein. For example, device 300 may correspond to components included in network device CPE controller 124, client device 130, wireless access station 145, network device 155, network device 175, AIML engine 230, or other devices in network environment 100. As illustrated in FIG. 3, according to an exemplary embodiment, device 300 includes a bus 305, processor 310, memory/storage 315 that stores software 320 and data, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, and/or clocks.

Processor 310 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc. Processor 310 may be a dedicated component or a non-dedicated component (e.g., a shared resource).

Processor 310 may control the overall operation, or a portion of operations, performed by device 300. Processor 310 may perform operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, etc.

Memory/storage 315 includes one or multiple memories and/or one or multiple other types of storage mediums. For example, memory/storage 315 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 315 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 315 may include a drive for reading from and writing to the storage medium.

Memory/storage 315 may be external to and/or removable from device 300, such as, for example, a Universal Serial Bus (USB) memory stick, a dongle, a hard disk, mass storage, off-line storage, network attached storage (NAS), or some other type of storage medium (e.g., a digital versatile disk (DVD), a Blu-Ray disk (BD), etc.). Memory/storage 315 may store data, software, and/or instructions related to the operation of device 300.

Software 320 includes an application or a program that provides a function and/or a process. Software 320 may include an operating system. Software 320 is also intended to include firmware, middleware, microcode, hardware description language (HDL), and/or other forms of instruction. For example, according to an implementation, software 320 may implement portions of the AIM system on client device 130, CPE controller 124, and user device AIML engine 230.

Communication interface 325 permits device 300 to communicate with other devices, networks, systems, devices, and/or the like. Communication interface 325 includes one or multiple wireless interfaces and/or wired interfaces. For example, communication interface 325 may include one or multiple transmitters and receivers, or transceivers. Communication interface 325 may include one or more antennas. For example, communication interface 325 may include an array of antennas. Communication interface 325 may operate according to a protocol stack and a communication standard. Communication interface 325 may include various processing logic or circuitry (e.g., multiplexing/de-multiplexing, filtering, amplifying, converting, error correction, etc.).

Input 330 permits an input into device 300. For example, input 330 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 335 permits an output from device 300. For example, output 335 may include a speaker, a display, a light, an output port, and/or some other type of visual, auditory, tactile, etc., output component. According to some embodiments, input 330 and/or output 335 may be a device that is attachable to and removable from device 300.

Device 300 may perform a process and/or a function, as described herein, in response to processor 310 executing software 320 in a computer-readable medium, such as memory/storage 315. A computer-readable medium may be defined as a non-transitory memory device. A memory device may be implemented within a single physical memory device or spread across multiple physical memory devices. By way of example, instructions may be read into memory/storage 315 from another memory/storage 315 (not shown) or read from another device (not shown) via communication interface 325. The instructions stored by memory/storage 315 cause processor 310 to perform a process described herein. Alternatively, for example, according to other implementations, device 300 performs a process described herein based on the execution of hardware (processor 310, etc.).

FIG. 4 is a diagram illustrating logical components of AIML engine 230. As shown in FIG. 4, AIML engine 230 may include a feature engineering module 410, a device/application classification module 420, a user pattern classification module 430, and a traffic optimization module 440. The components of FIG. 4 may be implemented, for example, by processor 310 in conjunction with memory 315.

Feature engineering module 410 may define the traffic feature representation from the data available on CPE controller 124 by dimension deduction technologies, such as principal component analysis (PCA).

Device/application classification module 420 may identify types of devices and/or applications based on expected traffic characteristics. With the device testing data in the lab, a machine learning (ML) model may be generated to learn to automatically classify the device types in terms of IOT, smartphone, tablets, etc. A hierarchical classification model may be built to further break down categories to traffic delay-sensitive device and traffic non-delay-sensitive devices based on, for example, historical user preference data. Recommendations may be given to newly added devices to help the customer set the device to the correct category (e.g., during a device/application registration process). Estimation of saving (e.g., play discounts, credits, etc.) can be provided to the customers (e.g., the user of an application/device) if a recommended setting for delay tolerance is accepted by the customer.

User pattern classification module 430 may create and apply a feature distance and voting based model to classify a customer usage pattern and corresponding peak hours for different kinds of traffic. An alarm system may be triggered when the customer pattern changes, which will impact the overall network optimization.

Traffic optimization module 440 may optimize traffic flow for individual wireless access stations 145. For example, considering all the FWA devices 120 connected to the same wireless access station 145, the flexibility of the delay-tolerant traffic can be defined to optimize the network traffic flow. According to an implementation, traffic optimization module 440 may use a penalty-based neural network to predict the optimized state of the traffic to maximize the traffic throughput. The penalty-based neural network may penalize traffic flow instances by the time that the peak traffic/utility percentage is higher than a threshold, and also the sum of additional delay added by the optimization. The model may be self-adjusting based on the neighbors (e.g., other FWA devices 120) connected on the same wireless access station 145. Model re-training may be triggered, for example, when the user pattern or device pattern changes in one of the neighbors. According to an implementation, AIML engine 230 may provide the model (referred to herein as a traffic management policy or routing policy) to individual AIM servers 220 in CPE networks 110 for implementation.

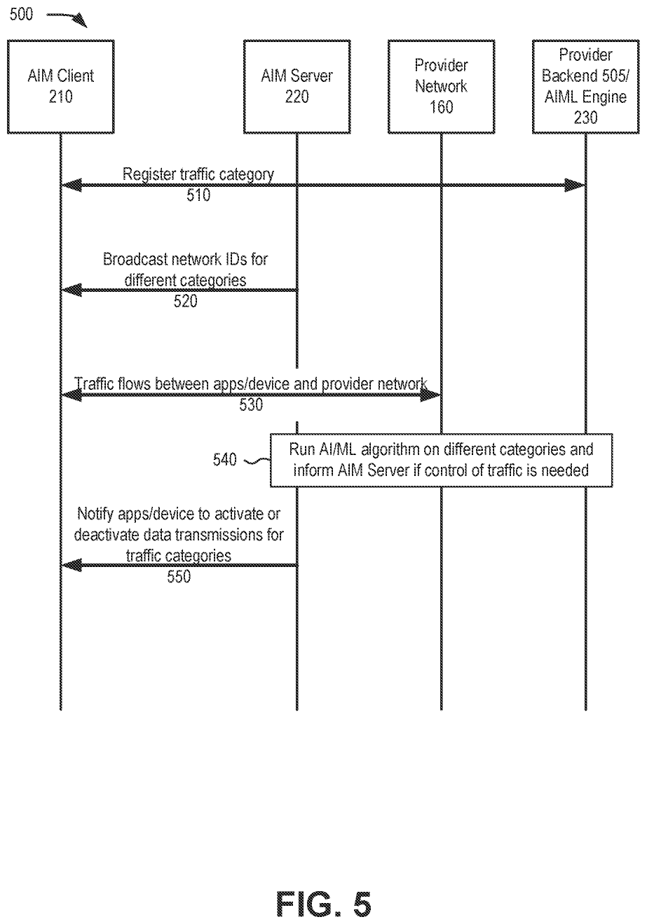

FIG. 5 is a diagram illustrating exemplary communications for providing static category-based multiplexing in a portion 500 of network environment 100. Network portion 500 may include provider network 160, AIM client 210, AIM server 220, and a provider backend network 505 (e.g., part of provider network 160 or a separate network) which may include AIML engine 230. FIG. 5 provides simplified illustrations of communications in network portion 500 and are not intended to reflect every signal or communication exchanged between devices. Furthermore, additional information not described herein may be communicated with some signals or communications.

As shown in FIG. 5, at signal 510, AIM client 210 may register for a traffic category. For example, particular applications and/or device associated with AIM client 210 may be assigned to one of multiple predetermined categories, such as “delay tolerant, cache friendly”, “immediate forwarding,” etc. If a category is not determined/selected, the traffic may default to an “immediate forwarding” category. AM client 210 may associate an application (e.g., application 205) with a category and store the association. According to an implementation, a customer may register an application as part of an initial installation process, for example.

Using signal 520, AIM server 220 may broadcast network identifiers (IDs) for the different network categories. For example, on the LAN side (e.g., CPE network 110), AIM server 220 may create separate network paths for the different traffic categories to join. AIM server 220 may identify, for example, different ethernet ports or different service set identifiers (SSIDs) for each traffic category.

As shown at reference 530, AIM client 210 and provider network 160 may exchange application traffic. For example, data from an application with a certain traffic category may be routed between CPE network 110 and provider network 160. Based on analysis from AIML engine 230, provider backend 505 may inform AIM server 220 that one or more traffic categories are being throttled (e.g., in accordance with a registered category), as indicated by reference 540.

Based on instructions from AIML engine 230, AIM server 230 may, at reference 550, notify the application/devices in CPE network 110 to activate or deactivate data transmissions for the designated traffic categories. For example, AIM server 230 may employ “out-of-band” signaling between the client devices 130 in the designated traffic category and update the client devices 130 when the “network congestion” status changes to activate/deactivate data sessions. According to an implementation, all traffic from a client device 130 will be treated the same way (e.g., delay-tolerant or not delay-tolerant) as being part of the same LAN subnet for FWA 120.

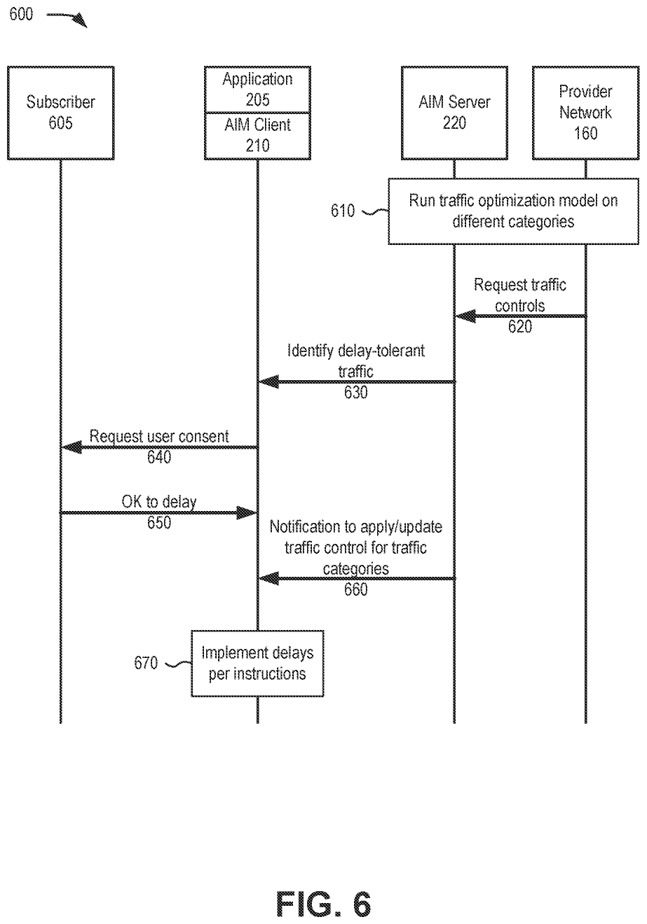

FIG. 6 is a diagram illustrating exemplary communications for providing dynamic application-specific multiplexing in a portion 600 of network environment 100. Network portion 600 may include a provider network 160, application 205 with AIM client 210, AIM server 220, and a subscriber 605. FIG. 6 provides simplified illustrations of communications in network portion 600 and are not intended to reflect every signal or communication exchanged between devices. Furthermore, additional information not described herein may be communicated with some signals or communications.

In the example of FIG. 6, instead of static assignment of a traffic category through registration as described in FIG. 5, the application 205/device 130 may not be assigned a predefined category. In the example of FIG. 6, the AIM server 220 may detect the kind of traffic dynamically and prompt application 205 to delay its transmission in times of network congestion. Thus, as shown in FIG. 6, at reference 610, AIM server 220 may apply the hieratical classification model generated by AIML engine 230 (e.g., device/application classification module 420) to dynamically detect the kind of traffic being transmitted to/from application 205 (e.g., based on traffic patterns, request/response history, etc.). AIM server 220 may run the hieratical classification model on different traffic categories, as well as network loading determinations.

At signal 620, based on analysis from AIML engine 230, provider network 160 may inform AIM server 220 that traffic controls are needed and/or that traffic for one or more traffic categories need to be limited. For example, provider network 160 may monitor network loads and identify a predicted or actual period of congestion associated with a cell (e.g., wireless access station 145). According to an implementation, signal 620 may be provided as a direct signal (e.g., a control plane signal) from wireless access station 145 to FWA 120/AIM server 220.

At reference 630, AIM server 220 may identify to AIM client 210 delay-tolerant traffic. For example, based on the traffic management policy from AIML engine 230, AIM server 220 may indicate that traffic associated with application 205 appears to be delay-tolerant and, thus, a candidate for delayed transmission during a congested period. According to an implementation, AIM server 220 may also provide incentive information, such as rewards, account credits, or discounts, that may be applicable if a subscriber (e.g., subscriber 605) consents to delayed transmissions.

At reference 640, AIM client 210 may request user consent to implement delays for application traffic from application 205. For example, AIM client 210 may present to subscriber 605 a message (e.g., a pop-up message) on client device 130 requesting user input. According to an implementation, the message may include a description of incentives (e.g., rewards, account credits, discounts, etc.) that may be applicable if subscriber 605 agrees to delayed transmissions for application 205. At reference 650, subscriber 605 may provide user input, which indicates that subscriber 605 agrees to implementing delayed transmissions for application 205.

At reference 660, AIM server 220 may provide a notification to AIM client 210/application 205 to apply traffic controls for the identified delay-tolerant traffic categories. For example, AIM server 220 may provide instructions in accordance with the traffic optimization model to have application 205 not send data (e.g., for a designated delay period or until instructed otherwise). According to one implementation, AIM server 220 may provide the instructions to AIM client 210 without knowing the user response at reference 650. In another implementation, AIM server 220 may be informed by AIM client 210 of the user response.

At reference 670, AIM client 210/application 205 may implement the instructions from AIM server 220, thus limiting outgoing traffic from (and subsequent responses to) application 205. For example, assuming permission is granted in reference 650, AIM client 210 may implement delays to temporarily prevent data from being sent by application 205 (e.g., based on instructions from AIM server 220).

While FIGS. 5 and 6 illustrate examples of communications for providing application-specific multiplexing, in other implementations, different communications or communication sequences may be used. For example, in FIG. 6, AIM server 220 may detect delay-tolerant traffic and AIM client 210 may request user consent for dynamic application-specific multiplexing before or after detecting possible/actual network congestion in a cell.

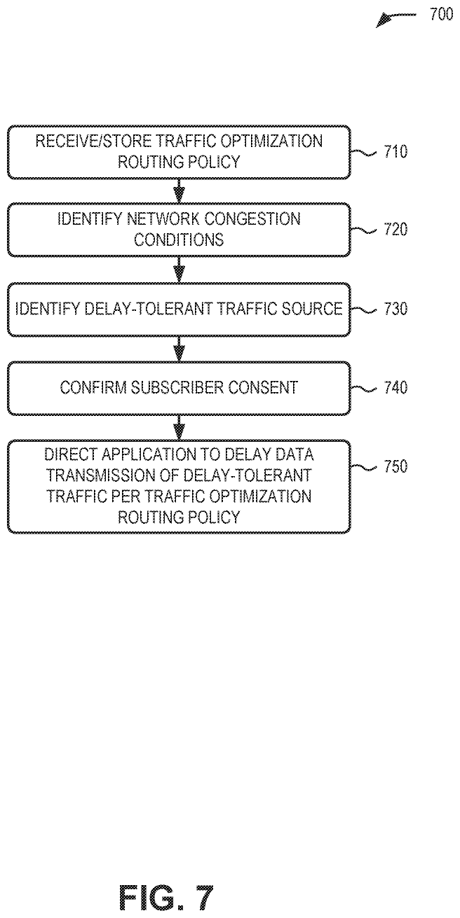

FIG. 7 is a flow diagram illustrating an example process 700 for providing intelligent multiplexing in a CPE network. In one implementation, process 700 may be implemented by AIM client 210 and AIM server 220. In another implementation, process 700 may be implemented by AIM client 210 and AIM server 220 in conjunction with one or more other devices in network portion 200.

Process 700 may include receiving and/or storing a traffic optimization routing policy (710). For example, AIM server 220 may receive a traffic optimization model from AIML engine 230 (e.g., traffic optimization module 440) and store the model in a local memory (e.g., memory 315). The traffic optimization model may include instructions or other criteria for applying limits/delays to certain types of traffic (e.g., when congestion conditions are present in the cell serving FWA device 120).

Process 700 may additionally include detecting network congestion conditions (720) and identifying a delay-tolerant traffic source (730). For example, in one implementation, provider network 160 (e.g., wireless access station 145/AIML engine 230) may detect network congestion (e.g., at a certain threshold level) and inform AIM server 220. In another implementation, AIM server 220 may detect network congestion based on CPE controller 124 monitoring of traffic conditions or receiving indications from sources residing in CPE network 110. Either preemptively, or in response to a congestion indication, AIM server 220 may identify one or more delay-tolerant traffic sources in CPE network 110. For example, in the context of static category-based multiplexing (e.g., FIG. 4), application 205 and/or client device 130 may be assigned a delay-tolerant category (e.g., “delay tolerant, cache friendly”) during a registration process. Alternatively, in the context of dynamic application-specific multiplexing (e.g., FIG. 5), AIML engine 230 and/or AIM server 220 may detect the kind of traffic from application 205 dynamically based on the application's traffic pattern and request/response history.

Process 700 may also include confirming subscriber consent (740). For example, in certain implementations, subscriber permission to pause transmission of delay-tolerant traffic may be obtained. For static category-based multiplexing, the registration process may include a consent process to obtain pre-authorization from a subscriber that delay-tolerant traffic may be subject to delayed transmissions. Alternatively, for dynamic application-specific multiplexing, AIM client 210 may solicit user input to confirm that the application can temporarily deactivate data transmissions during a period of network congestion.

Process 700 may further include directing an application to delay data transmission of delay-tolerant traffic per the traffic optimization routing policy (750). For example, AIM server 220 may communication with AIM client 210 to implement the traffic optimization model. In one implementation, AIM server 220, in response to detecting network congestion (and any subsequent subscriber consent, if necessary), may inform AIM client 210 to stop application 205 from transmitting data during a particular period or until AIM client 210 is notified that there are no longer congestion conditions.

Systems and methods describe herein intelligently multiplex different types of traffic by communicating with customer applications directly so that network capacity can be maximized for time-sensitive traffic. An AIML engine provides models to allow CPE equipment to intelligently identify the type of traffic that needs immediate attention. The AIML engine may use artificial intelligence to learn traffic patterns, identify network loading/congestion, and learn neighboring traffic patterns to derive a traffic management policy.

Users may be given a choice to have only time-sensitive traffic served (from applications or devices) while postponing delay tolerant traffic during periods of network congestion. In return the user may receive credit for delayed transmission of other traffic (which may be conveyed back to the network at non-congested periods). If a user consents (e.g., via device/application registration or express consent during dynamic multiplexing) to delay-tolerant categorization, traffic from the delay-tolerant applications/devices that is sent during a network congestion period may be dropped. When the network congestion period changes, FWA device 120 may notify the delay-tolerant applications/devices to activate its transmission (in both uplink and downlink directions).

The foregoing description of implementations provides illustration but is not intended to be exhaustive or to limit the invention to the precise form disclosed. Modifications and variations are possible in light of the above teachings or may be acquired from practice of the invention. For example, while a series of blocks have been described with regard to FIG. 7, and message/operation flows with respect to FIGS. 5 and 6, the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a routing device in a customer premises network, a routing policy;
identifying, by the routing device, an indication of network congestion conditions;
identifying, by the routing device, one or more source of delay-tolerant traffic in the customer premises network; and
applying, by the routing device, the routing policy to delay data transmissions from the source based on identifying the indication of network congestion conditions.

2. The method of claim 1, wherein the routing device includes a fixed wireless access (FWA) device for the customer premises network.

3. The method of claim 1, wherein identifying the indication of network congestion conditions includes one of:
receiving, via a broadcast signal from a base station, a network identifier for a delay-tolerant traffic category, or
receiving, from the base station, a control plane signal indicating network congestion conditions.

4. The method of claim 1, wherein identifying the indication of network congestion conditions includes:
monitoring, by the routing device, packet headers for congestion notifications, or
monitoring an uplink queue for congestion.

5. The method of claim 1, further comprising:
obtaining, by the client device, subscriber consent for delaying the data transmissions.

6. The method of claim 1, further comprising:
receiving, via a registration process, a traffic category for the source.

7. The method of claim 1, wherein the identifying includes:
dynamically detecting a kind of traffic associated with the application based one or more of a traffic pattern and a request/response history.

8. The method of claim 1, wherein the network device includes a fixed wireless access (FWA) router, and wherein the source of the delay-tolerant traffic includes a client device connected to the FWA router.

9. The method of claim 1, wherein the source of delay-tolerant traffic includes one of a client device or an application executed on the client device.

10. The method of claim 1, further comprising:
deriving, by another device in a core network, a machine-learning model to generate the routing policy for the base station.

11. A system, comprising:
a routing device in a customer premises network, the routing device configured to:
receive, from a core network, a routing policy;
identify an indication of network congestion conditions;
identify a source of delay-tolerant traffic in the customer premises network; and
apply the routing policy to delay data transmissions from the source based on identifying the indication of network congestion conditions.

12. The system of claim 11, wherein the routing device includes a fixed wireless access (FWA) device for the customer premises network.

13. The system of claim 11, wherein, when identifying the indication of network congestion conditions, the routing device is further configured to:
receive, via a broadcast signal from a base station, a network identifier for a traffic category.

14. The system of claim 11, wherein, when identifying the indication of network congestion conditions, the routing device is further configured to:
receive, from a base station, a control plane signal indicating network congestion conditions.

15. The system of claim 11, wherein, when identifying the source of delay-tolerant traffic, the routing device is further configured to:
dynamically detect a kind of traffic associated with the application based one or more of a traffic pattern and a request/response history.

16. The system of claim 11, wherein the delay-tolerant traffic source includes a client device connected, via a wireless connection, to the routing device.

17. The system of claim 11, further comprising:
a client device including application configured to:
receive instructions from the routing device to delay data transmissions, and
obtain subscriber consent for delaying the data transmissions.

18. A non-transitory computer-readable storage medium containing instructions, executable by at least one processor of a routing device, for:
receiving, by the routing device in a customer premises network, a routing policy;
identifying, by the routing device, an indication of network congestion conditions;
identifying, by the routing device, a source of delay-tolerant traffic in the customer premises network; and
applying, by the routing device, the routing policy to delay data transmissions from the source based on identifying the indication of network congestion conditions.

19. The non-transitory computer-readable storage medium of claim 18, wherein the instructions for identifying the indication of network congestion conditions further comprise instructions for:
receiving, via a broadcast signal from a base station, a network identifier for a traffic category.

20. The non-transitory computer-readable storage medium of claim 18, wherein the instructions for identifying the indication of network congestion conditions further comprise instructions for:
receiving, from a host application, a signal indicating network congestion conditions.
